(19) United States
(12) Patent Application Publication
(10) Pub. No.: US 2017/0125052 A1
(43) Pub. Date: May 4, 2017

(54) MAGNETIC DISK DEVICE AND CORRECTION METHOD FOR REFRESH PROCESSING

(71) Applicant: Kabushiki Kaisha Toshiba, Tokyo (JP)

(72) Inventor: Ryuichi Sato, Kawasaki Kanagawa (JP)

(21) Appl. No.: 15/061,215

(22) Filed: Mar. 4, 2016

Related U.S. Application Data
(60) Provisional application No. 62/257,505, filed on Nov. 19, 2015.
(60) Provisional application No. 62/249,046, filed on Oct. 30, 2015.

(51) Int. Cl. G11B 20/10

(52) U.S. Cl. CPC G11B 20/10481

(57) ABSTRACT

According to one embodiment, a magnetic disk device in includes a disk including a recording surface, a head configured to write and read data to and from the disk, and a controller configured to correct a threshold value causing data written in a track in at least one recording area of recording areas radially sectioned on the recording surface of the disk to be rewritten according to an index value indicative of signal quality of the data in the track and variable with the number of times of executed writing into the track.

### CROSS-REFERENCE TO RELATED APPLICATIONS

This application claims the benefit of U.S. Provisional Applications No. 62/249,046, filed Oct. 30, 2015; and No. 62/257,505, filed Nov. 19, 2015, the entire contents of all of which are incorporated herein by reference.

### FIELD

Embodiments described herein relate generally to a magnetic disk device and correction method for refresh processing of the magnetic disk device.

### BACKGROUND

In a magnetic disk device, when a write operation is executed at a particular track, an adjacent track may receive a leakage flux from a head, and data written in the adjacent track may be erased under the influence of the leakage flux (adjacent track interference [ATI]). Namely, what is called side erasure may occur. The influence of the leakage flux from the head may vary with characteristics of the head, a tracks-per-inch (TPI) setting, a write current setting, etc., for example.

In order to prevent the side erasure, the magnetic disk device has a function (refresh function) which will be triggered when the number of writes (write number) to a particular track reaches a prescribed number of times (a refresh threshold value) and will rewrite data written in adjacent tracks near the particular track.

In the conventional refresh function, a refresh threshold may be set for every one of areas into which the disk is sectioned along a radius at particular intervals. A refresh threshold is set based on the magnitude of influence (hereinafter referred to as an index value) which has been measured in advance and which has been exerted from write operation repeatedly executed at any adjacent tracks. Since it is difficult to obtain by measurement an index value for every track of every area when setting a refresh threshold, some index values are obtained by making measurements on some tracks for each area. Namely, a refresh threshold is set based on the index values of some tracks for each area. Therefore, a refresh threshold may not correctly reflect the difference in characteristics among all the tracks in each area. Thus, the magnetic disk device may be unable to subject other tracks in each area to their respective refresh processes at their respective appropriate moments.

### BRIEF DESCRIPTION OF THE DRAWINGS

FIG. 1 is a block diagram showing a structure of a magnetic disk device of one embodiment.

FIG. 2 is a view illustrating an exemplary measurement result of a VMM for every head in the recording area of a disk.

FIG. 3 is a view illustrating an exemplary zone profile of a refresh threshold value of the recording area of the disk.

FIG. 4 is a diagram showing an exemplary data group relevant to a refresh process.

FIG. 5A is a view illustrating a part of an exemplary correction of an approximate expression of an outer circumferential region.

FIG. 5B is a view illustrating the other part of the exemplary correction of the approximate expression of the outer circumferential region.

FIG. 6 is a view illustrating an exemplary correction of a refresh threshold value of the outer circumferential region.

FIG. 7 is a flowchart of a correction process of the refresh threshold value of the embodiment.

FIG. 8 is a view illustrating an exemplary correction of an approximate expression of the outer circumferential region of a modification 1.

FIG. 9 is a view illustrating an exemplary correction of a refresh threshold value of the outer circumferential region of the modification 1.

FIG. 10 is a flowchart of a correction process of the refresh threshold value of the modification 1.

FIG. 11 is a view illustrating an exemplary correction of an approximate expression of the outer circumferential region of a modification 2.

FIG. 12 is a view illustrating an exemplary correction of a refresh threshold value of the outer circumferential region of the modification 2.

FIG. 13 is a flowchart of a correction process of the refresh threshold value of the modification 2.

### DETAILED DESCRIPTION

In general, according to one embodiment, a magnetic disk device in comprises: a disk comprising a recording surface; a head configured to write and read data to and from the disk; and a controller configured to correct a threshold value causing data written in a track in at least one recording area of recording areas radially sectioned on the recording surface of the disk to be rewritten according to an index value indicative of signal quality of the data in the track and variable with the number of times of executed writing into the track.

Now, one embodiment will be explained with reference to the drawings.

### Embodiment

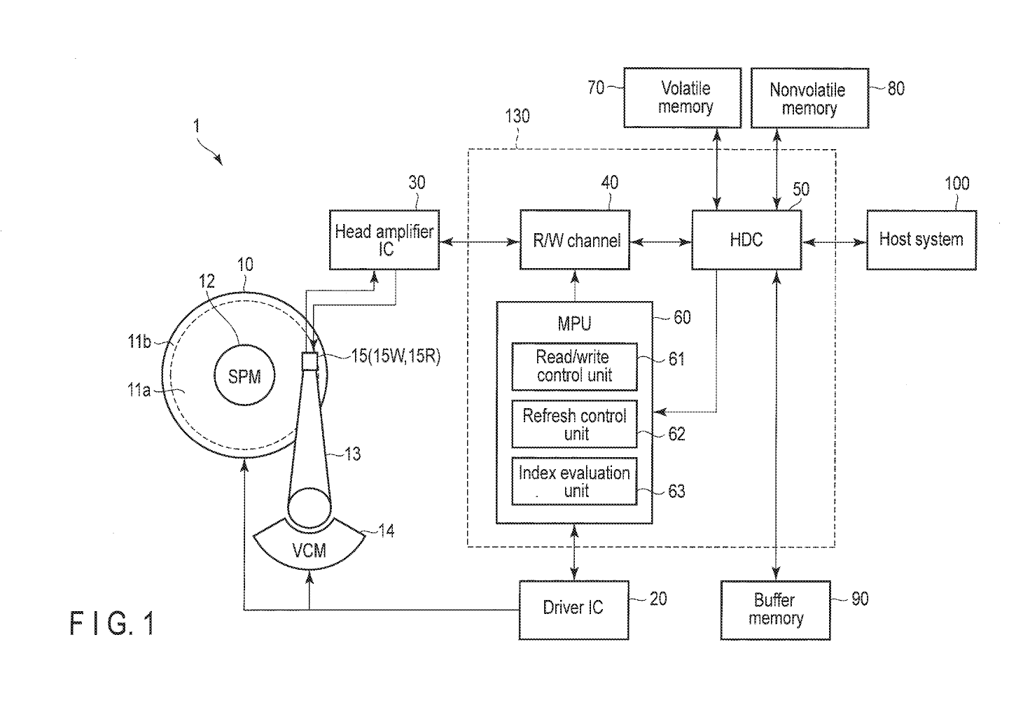

FIG. 1 is a block diagram showing a structure of a magnetic disk device 1 of one embodiment.

The magnetic disk device 1 includes a head-disk assembly (HDA) described later, a driver IC 20, a head amplifier integrated circuit (hereinafter referred to as a head amplifier IC) 30, a volatile memory 70, a nonvolatile memory 80, a buffer memory (buffer) 90 and a system controller 130 composed of a one-chip integrated circuit. The magnetic disk device 1 is connected to a host system (host) 100.

The HDA includes a magnetic disk (hereinafter referred to as a disk) 10, a spindle motor (SPM) 12, an arm 13 with a head 15 and a voice coil motor (VCM) 14. The disk 10 is rotated by the SPM 12. The arm 13 and VCM 14 constitute an actuator. The actuator moves the head 15 on the arm 13 to a particular position on the disk 10 in accordance with driving of the VCM 14. Two or more disks 10 and two or more heads 15 may be employed.

The disk 10 has a data area, to which a recording area 11a that can be used by a user, and a system area 11b for storing data necessary for system management, are allocated.

The head 15 comprises a write head 15W and a read head 15R mounted on a slider serving as a main body. The read head 15R reads data from a data track on the disk 10. The write head 15W writes data to the disk 10.

The driver IC 20 controls driving of the SPM 12 and the VCM 14 in accordance with control of the system controller 130 (which will be described as an MPU 60 later).

The head amplifier IC 30 includes a read amplifier and a write driver. The read amplifier amplifies a read signal read out by the read head 15R and transmits the amplified signal to a read/write (R/W) channel 40. The write driver transmits write current which corresponds to write data output from the R/W channel 40, to the write head 15W.

The volatile memory 70 is a semiconductor memory of which data is lost when a power supply is shut off. The volatile memory 70 stores, for example, data necessary for processing in each unit of the magnetic disk device 1. The volatile memory 70 is, for example, a synchronous dynamic random access memory (SDRAM).

The nonvolatile memory 80 is a semiconductor memory that holds saved data even if the supply of power thereto is interrupted. The nonvolatile memory 80 is a flash read-only memory (FROM), for example.

The buffer memory 90 is a semiconductor memory that temporarily holds, for example, data to be transmitted between the disk 10 and the host system 100. The buffer memory 90 may be provided integral with the volatile memory 70 as one body. The buffer memory 90 is, for example, a dynamic random access memory (DRAM), a static random access memory (SRAM), an SDRAM, a ferroelectric random access memory (FeRAM), or a magnetoresistive random access memory (MRAM).

The system controller 130 is achieved using a large scale integrated circuit (LSI) called a system-on-a-chip (SoC) that is a single chip on which a plurality of elements are integrated, for example. The system controller 130 includes the read/write (R/W) channel 40, a hard disk controller (HDC) 50, and the microprocessor (MPU) 60.

The R/W channel 40 executes signal processing of read data and write data. The R/W channel 40 has a function of or a circuit for measuring the signal quality of read data.

The HDC 50 controls the data transfer between the host system 100 and the R/W channel 40 according to the instructions from the MPU 60.

The MPU 60 is a main controller that controls each unit of the magnetic disk device 1. The MPU 60 controls the VCM 14 through the driver IC 20 and performs servo control to position the head 15. Moreover, The MPU 60 controls a data read/write operation into the disk 10.

The MPU 60 includes a read/write control unit 61, a refresh control unit 62, and an index evaluation unit 63. The MPU 60 performs processes of these units on firmware.

The read/write control unit 61 executes data read/write control according to the command from the host 100. The read/write control unit 61 counts the number of times of executed writing into a track adjacent to a particular track (henceforth, an adjacent track) occurs (specifically, it obtains a count value based on the number of writes [write number]). In the following, the number write may sometimes be called simply a count value.

The refresh control unit 62 controls a rewrite process (refresh process), in which a particular recording area of the disk 10 is once read and what has been read is written back to the particular recording area 11a. For example, when the count of a particular area exceeds a preset value (refresh threshold value), the refresh control unit 62 subjects the particular area to a refresh process.

The index evaluation unit 63 evaluates the value (hereinafter also referred to simply as an index value) indicative of the signal quality of the read signal (hereinafter also referred to simply as the signal quality). The index evaluation unit 63 acquires, when reading a particular track, the actual measured value (measured value) of an index value (hereinafter referred to as an actual measured value) and the count value of the read track. Moreover, the index evaluation unit 63 calculates a predicted value of an index value (hereinafter also called a predicted value) by assigning the acquired count value to the approximate expression of an index value indicating the relationship between a count value and an index value. The index evaluation unit 63 compares the actual measured value acquired at the time of reading with the predicted value calculated by the approximate expression. Here, the index value may be a Viterbi metric margin (VMM), an error rate, or the number of bits of a correction error, for example. The index evaluation unit 63 corrects the refresh threshold value and the approximate expression of an index value based on the comparison result between a actual measured value and a predicted value.

(Correction Method for Refresh Threshold Value)

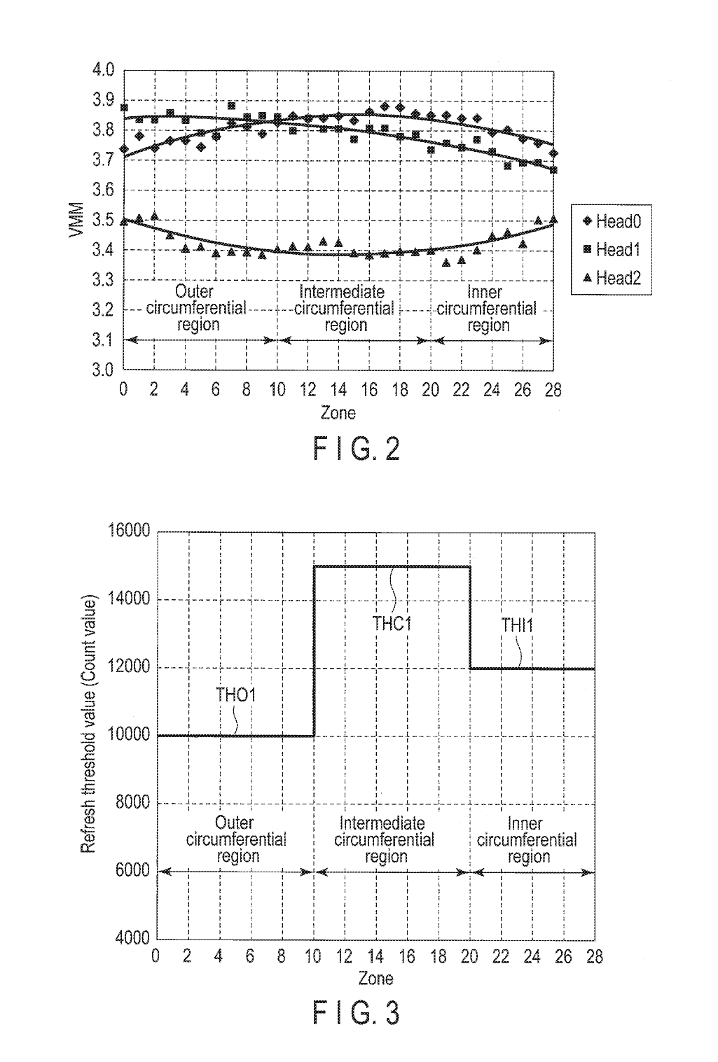

FIG. 2 is a view illustrating the exemplary results of having measured a VMM for every head in the recording area 11a of the disk 10. FIG. 3 is a view illustrating an exemplary zone profile of the refresh threshold value of the recording area 11a of the disk 10.

The MPU 60 sections the recording area 11a into areas, each having a particular size (hereinafter referred to as a zone). Each zone includes tracks.

For example, as shown in FIG. 2 and FIG. 3, the MPU 60 divides into 28 zones the recording area 11a, which spreads from its inner circumference to its outer circumference. In the recording area 11a, zones 0 to 9 are classified into an outer circumferential region, zones 10 to 19 into an intermediate circumferential region, and zones 20 to 28 into an inner circumferential region.

In FIG. 2, the vertical axis represents VMM and the horizontal axis represents the zone of the recording area 11a. FIG. 2 illustrates the measured value of every VMM of each zone when 30,000 write processes are executed in each zone of the recording area 11a. Moreover, in FIG. 2, Head 0, Head 1, and Head 2 represent different individual heads. A VMM is in good correlation with an error occurrence rate at the time of reading (hereinafter simply referred to as an error rate). Accordingly, a VMM can be used as the probability of reading errors.

As shown in FIG. 2, Head 0, Head 1, and Head 2 individually indicate a tendency to be different in VMM from zone to zone. As shown in FIG. 2, Head 0 indicates that the outer circumferential region is smaller in VMM than the intermediate circumferential region or the inner circumferential region. Head 1 indicates that the inner circumferential region is smaller in VMM than the outer circumferential region or the intermediate circumferential region. Head 2 indicates that the intermediate circumferential region is smaller in VMM than the outer circumferential region or the inner circumferential region.

In FIG. 3, the vertical axis represents refresh threshold values (count values), and the horizontal axis represents the zone of the recording area 11a of the disk 10. FIG. 3 indicates a refresh threshold value THO1 applicable to zones 0-9, a refresh threshold value THC1 applicable to zones 10-19, and a refresh threshold value THI1 applicable to zones 20-28.

The MPU 60 sets a refresh threshold value for every region in a manufacturing process based on an index value of a specific zone previously measured in each region, including the outer circumferential region, the intermediate circumferential region, and the inner circumferential region, for example. The MPU 60 stores the refresh threshold value of each area in a storage medium, such as a system area 11b, a nonvolatile memory 80, etc., for example.

For example, as shown in FIG. 3, the MPU 60 may set to 10,000 the refresh threshold value THO1 of the outer circumferential region. In this case, the MPU 60 may set as the refresh threshold value THO1 of the outer circumferential region a count value which is obtained when the index value of a zone 0 previously acquired by measurement, such as a VMM, reaches a specific value. Here, a specific value is a signal quality value which indicates whether a refresh process should be done.

The MPU 60 may set to 15,000 the refresh threshold value THC1 of the intermediate circumferential region. In this case, the MPU 60 may set as the refresh threshold value THC1 of the intermediate circumferential region a count value which is obtained when the index value of a zone 14 previously acquired by measurement, such as a VMM, reaches a specific value.

Moreover, the MPU 60 may set to 12,000 the refresh threshold value THI1 of the inner circumferential region. In this case, the MPU 60 may set as the refresh threshold value THI1 of the inner circumferential region a count which is obtained when the index value of a zone 28 previously acquired by measurement, such as a VMM, reaches a specific value.

When a refresh threshold value is set in this way based on the index value of a specific zone in each region, an index value of any one of those zones other than the specific zone of each region can exceed the specific value before reaching the refresh threshold value. Furthermore, when the index value of a particular zone exceeds a specific value and reaches a particular value (hereinafter referred to as an upper limit value) which constitutes a read error, the MPU 60 may determine a read error upon reading written data kept in the particular zone.

Referring to FIG. 2 when the refresh threshold value of Head 0 is set based on the measurement result of the VMM of the zone 0, for example, the index value of every surrounding track in the zone 10 may exceed a specific value or upper limit value before reaching a refresh threshold value.

As mentioned above, the MPU 60 manages data groups, such as count values and index values, for every zone of every region so that a refresh process can be executed before an index value exceeds the upper limit.

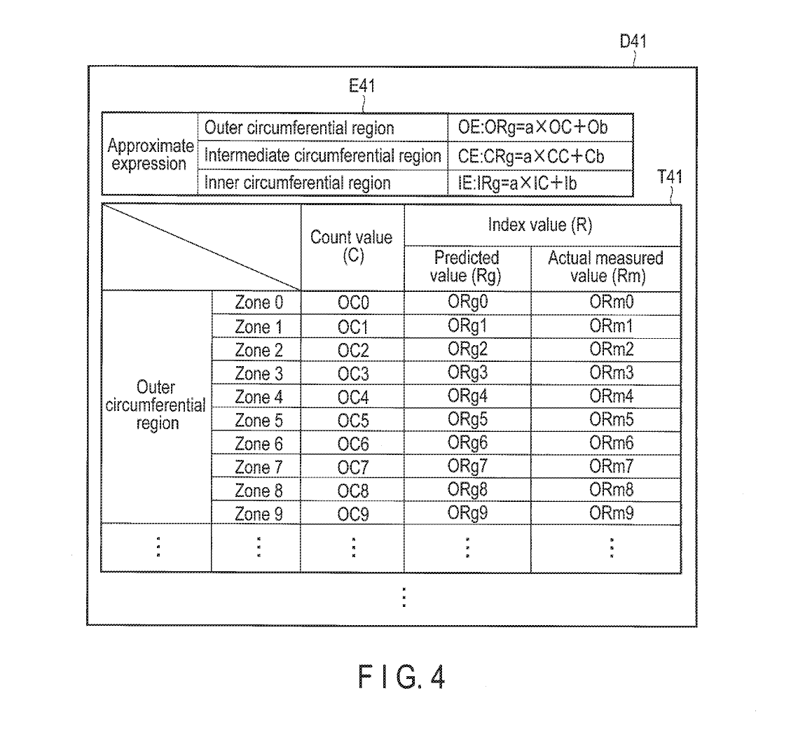

FIG. 4 is a diagram showing an exemplary data group D41 relevant to a refresh process. The data group D41 includes a table T41 and an approximate expression E41. The MPU 60 stores the data group D41 in a storage medium such as a system area 11b or a nonvolatile memory 80, for example.

Table T41 includes the count value C and the index value R for every zone of the disk 10. It is possible that the MPU 60 may use table T41 to manage the count value C and an index value R for every track. For convenience of explanation, the count value C and index value R of the outer circumferential region alone are indicated in table T41. However, table T41 further comprises the count value C and index value R of the intermediate circumferential region, and the count value C and index value R of the inner circumferential region.

Here, the count value C is a count for every adjacent track in each zone. The count value C may be a count value of a specific track of tracks included in each zone, or may be an average of count values of the respective tracks included in each zone. The index value R includes a predicted value Rg and an actual measured value Rm. The predicted value Rg is an index value calculated from the count value C and the approximate expression E41. The actual measured Value Rm is an index value acquired upon reading the track included in each zone.

The approximate expression E41 indicates the relationship between the count value C and the index value R for a particular area. The approximate expression E41 is previously acquired by measurement. For example, the approximate expression E41 may be derived from four count values indicative of four specific tracks in a particular zone of each area and four measured values acquired as four index values by measuring the four tracks indicated by the four counts. The approximate expression E41 includes an approximate expression OE of the outer circumferential region, an approximate expression CE of the intermediate circumferential region, and an approximate expression IE of the inner circumferential region.

In the approximate expression E41, ORg stands for a predicted value of the outer circumferential region, CRg for a predicted value of the intermediate circumferential region, and IRg for a predicted value of the inner circumferential region. Moreover, OC stands for a count of the particular zone of the outer circumferential region, CC for a count value of the particular zone of the intermediate circumferential region, and IC for a count value of the particular zone of the inner circumferential region.

In the present embodiment, an inclination a is a fixed value. The inclination a is the same among the approximate expressions OE, CE, and IE. It is however possible that the inclination a may be different among the approximate expressions OE, CE, and IE, or may be variable in each of the approximate expressions OE, CE, and IE. Moreover, the absolute terms Ob, Cb, and Ib are different. However, it is possible that the absolute terms Ob, Cb, and Ib may be the same.

When the count value C of a zone in a particular area reaches a refresh threshold of the particular area, the MPU 60 subjects the zone to a refresh process.

The MPU 60 calculates the predicted value Rg with reference to the approximate expression E41 and the count value C. For example, the MPU 60 calculates the predicted value ORg with reference to the approximate expression OE and the count value OC. Whenever the count value C is updated, the MPU 60 calculates the predicted value Rg, and updates table T41.

Moreover, when the particular track included in a particular zone is read, the MPU 60 acquires the actual measured value Rm of the read track. When the actual measured value Rm is acquired, the MPU 60 compares the acquired actual measured value Rm with the predicted value Rg of a zone which includes the track. When the comparison result indicates that the actual measured value Rm is different from the predicted value Rg, the MPU 60 corrects the approximate expression E41 and refresh threshold value of the region, to which the zone including the read track belongs.

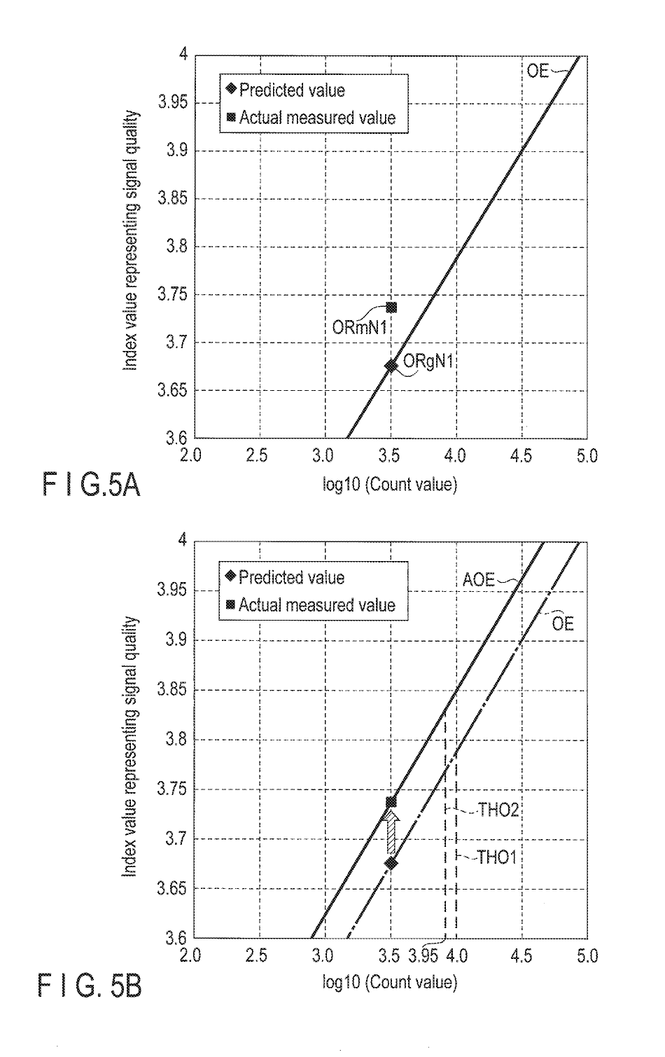

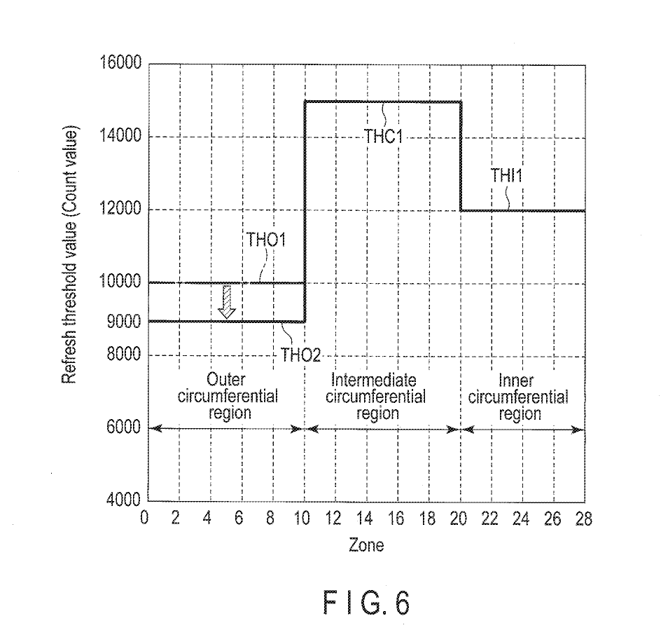

FIG. 5A and FIG. 5B are views illustrating an example of how to correct the approximate expression of the outer circumferential region, and FIG. 6 is a view illustrating an example of how to correct the refresh threshold value of the outer circumferential region. In FIG. 5A and FIG. 5B, the vertical axis represents the index value which represents signal quality, and the horizontal axis represents the count value as a common logarithm. Moreover, in FIG. 6, the vertical axis represents the refresh threshold value (count value), and the horizontal axis represents the zone of the recording area 11a.

In FIG. 5A and FIG. 5B, the straight line OE is expressed by the approximate expression of the outer circumferential region illustrated in FIG. 4. Point ORgN1 on the straight line OE indicates the predicted value Rg of the particular zone of the outer circumferential region. Point ORmN1 indicates the actual measured value Rm acquired when a track included in a particular zone is read. Moreover, in FIG. 5B, the straight line AOE is expressed by the approximate expression which is obtained by correcting the approximate expression OE. In FIG. 5B and FIG. 6, THO1 indicates the refresh threshold value of the outer circumferential region before correction, and THO2 indicates the refresh threshold value of the outer circumferential region after correction.

When the actual measured value Rm acquired when the track included in a particular zone is read is larger than the predicted value Rg of the particular zone, the MPU 60 corrects the approximate expression E41 and refreshes the threshold of a region including the particular zone.

For example, as illustrated in FIG. 5A, upon having read the particular zone of the outer circumferential region, the MPU 60 acquires the actual measured value ORmN1 and the count value OC of the read particular zone, such as 10^{3.5}, for instance.

The MPU 60 calculates a predicted value ORgN1 with reference to the approximate expression OE and the count OC (10^{3.5}). The MPU 60 compares the acquired actual measured value ORmN1 with the calculated predicted value ORgN1.

When the actual measured value ORmN1 is larger than the predicted value ORgN1 as illustrated in FIG. 5A, the MPU 60 substitutes the approximate expression AOE for the approximate expression OE as illustrated in FIG. 5B, so that the line expressed by the approximate expression OE may pass through the actual measured value ORmN1.

At this moment, the refresh threshold value THO1 (count: 10,000) in the outer circumferential region is reduced by 10% by the MPU 60, and thus is corrected to the refresh threshold value THO2 (count: 9,000), as illustrated in FIG. 6.

The MPU 60 furthermore can correct the approximate expression and refresh threshold value of the intermediate circumferential region and those of the inner circumferential region similarly as correction of the approximate expression E41 and refresh threshold value of the outer circumferential region.

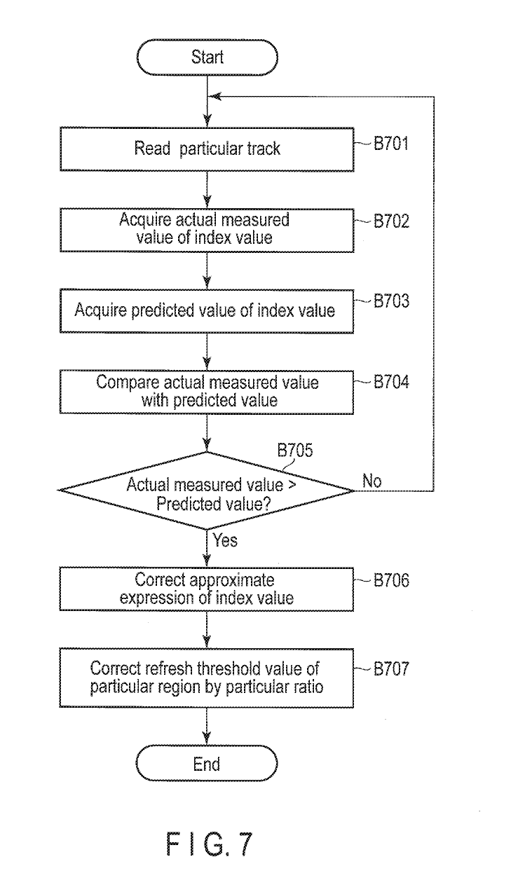

FIG. 7 is a flow chart of a correction process of the refresh threshold value of the present embodiment.

The MPU 60 reads a particular track of the recording area 11a (B701). The MPU 60 acquires the actual measured value Rm of the read particular track (B702), and acquires the predicted value Rg of the index calculated from the approximate expression of the region, to which the zone including the particular track belongs, and the count value of the zone (B703).

The MPU 60 compares the acquired actual measured value Rm and the predicted value Rg (B704), and determines from a comparison result whether the actual measured value Rm is larger than the predicted value Rg (B705).

When it is determined that the actual measured value Rm is smaller than the predicted value Rg (NO of B705), the MPU 60 returns to the process of B701. When it is determined that the actual measured value Rm is larger than the predicted value Rg (YES of B705), the MPU 60 corrects the approximate expression of the index value based on the actual measured value (B706).

The MPU 60 corrects the refresh threshold value of the region including the read zone by a particular ratio (B707), and ends the process. Here, the MPU 60 executes correction which reduces by 10% the refresh threshold value of the region including the read zone, for example.

The magnetic disk device 1 in the present embodiment corrects the approximate expression for calculating the predicted value Rg, when the actual measured value Rm which is acquired by reading the particular track is larger than the predicted value Rg of the zone including the track. At this moment, the magnetic disk device 1 corrects the refresh threshold value of the region to which the zone where the track is included belongs by a particular ratio. Accordingly, the magnetic disk device 1 can subject the particular zone to a refresh process before the index value of the particular zone reaches the upper limit value. Therefore, the magnetic disk device 1 will improve in reliability.

Subsequently, a modification of the magnetic disk device in the present embodiment will be explained. In the modification, the same reference marks will be attached to the same sections as those of the embodiment mentioned above, and the detailed explanation will be omitted.

(Modification 1)

In a case where the actual measured value Rm acquired when a particular track is read is larger than the predicted value Rg of a zone including the track, the MPU 60 in the modification 1 corrects the refresh threshold value of the region, to which the zone including the track belongs, based on the rate of change between the actual measured value Rm and predicted value Rg of a particular zone.

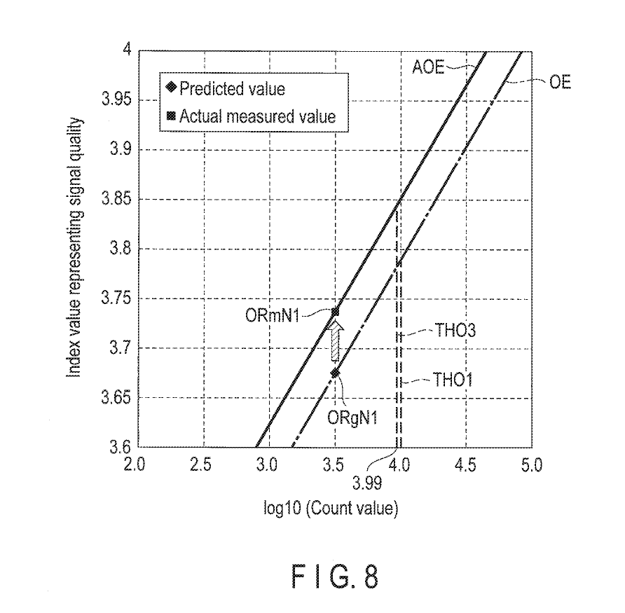

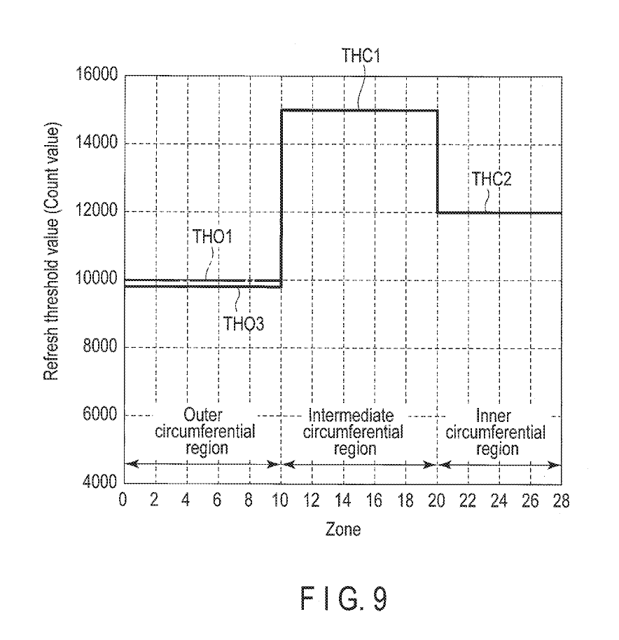

FIG. 8 is a view illustrating an example of how to correct the approximate expression of the outer circumferential region of the modification 1. FIG. 9 is a view illustrating an example of how to correct the refresh threshold of the outer circumferential region of the modification 1. In FIG. 8, the vertical axis represents the index value which represents signal quality, and the horizontal axis represents the count value as a common logarithm. Moreover, in FIG. 9, the vertical axis represents the refresh threshold value (count value), and the horizontal axis represents the zone of the recording area 11a. In FIG. 8 and FIG. 9, THO3 indicates the refresh threshold of value the outer circumferential region after correction.

The MPU 60 acquires the actual measured value Rm when the track included in a particular zone has been read. The MPU 60 also acquires the predicted value Rg of the particular zone including the read track. The MPU 60 calculates the rate of change between the actual measured value Rm and predicted value Rg. For example, the MPU 60 acquires actual measured value ORmN1 when the track included in a particular zone has been read. The MPU 60 also acquires predicted value ORgN1 of a particular zone including the read track. The MPU 60 then calculates the rate of change between the actual measured value ORmN1 and predicted value ORgN1 (=ORgN1/ORmN1).

As illustrated in FIG. 9, the MPU 60 carries out correction which reduces the outer circumferential region from the refresh threshold value THO1 to the refresh threshold value THO3 based on the rate of change between the actual measured value ORmN1 and the predicted value ORgN1.

Furthermore, the MPU 60 can correct the approximate expression and refresh threshold value of the intermediate circumferential region and those of the inner circumferential region similarly as correction of the approximate expression E41 and refresh threshold value of the outer circumferential region.

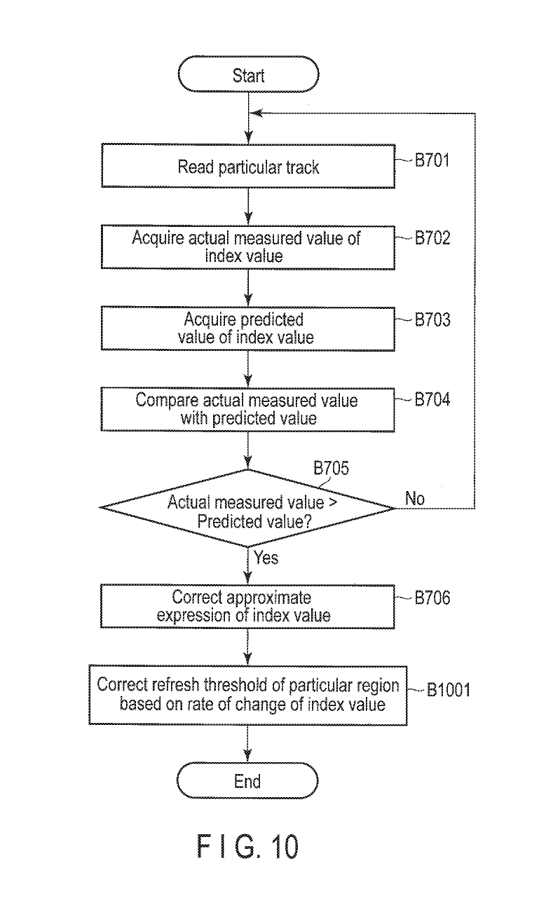

FIG. 10 is a flow chart of a correction process of the refresh threshold value of the modification 1. In the flow chart of FIG. 10, the same reference marks will be attached to those processes that are equivalent to those illustrated in the flow chart of FIG. 7, and the detailed explanation will be omitted.

The MPU 60 reads a particular track (B701), acquires the actual measured value Rm of the index value of the read particular track (B702), and acquires the predicted value Rg of the index value of a zone including the particular track (B703).

The MPU 60 compares the acquired actual measured value Rm and the acquired predicted value Rg (B704), and determines whether the actual measured value Rm is larger than the predicted value Rg (B705).

When it is determined that the actual measured value Rm of the index value is smaller than the predicted value Rg (NO of B705), the MPU 60 returns to the process of B701. When it is determined that the actual measured value Rm is larger than the predicted value Rg (YES of B705), the MPU 60 corrects the approximate expression of the index value (B706).

The MPU 60 corrects refresh threshold value THO1 of the region, to which the zone including the track belongs, based on the rate of change between the actual measured value Rm acquired by reading the particular track and the predicted value Rg of the zone including the track (B1001), and ends the process.

The magnetic disk device 1 in the present modification corrects the approximate expression for calculating the predicted value Rg, when the actual measured value Rm which is acquired by reading the particular track is larger than the predicted value Rg of a zone including the track. At this moment, based on the rate of change between the actual measured value Rm acquired by reading the particular track and the predicted value Rg of the zone including the track, the magnetic disk device 1 corrects the refresh threshold value of the region, to which the zone including the track belongs. Accordingly, the magnetic disk device 1 can subject the particular zone to a refresh process before the index value of the particular zone reaches the upper limit value.

(Modification 2)

In the modification 2, in a case where the actual measured value Rm acquired when a particular track is read is larger than the predicted value Rg of a zone including the track, the MPU 60 corrects the refresh threshold value of the region, to which the zone including the track belongs, based on the particular index and the approximate expression AOE.

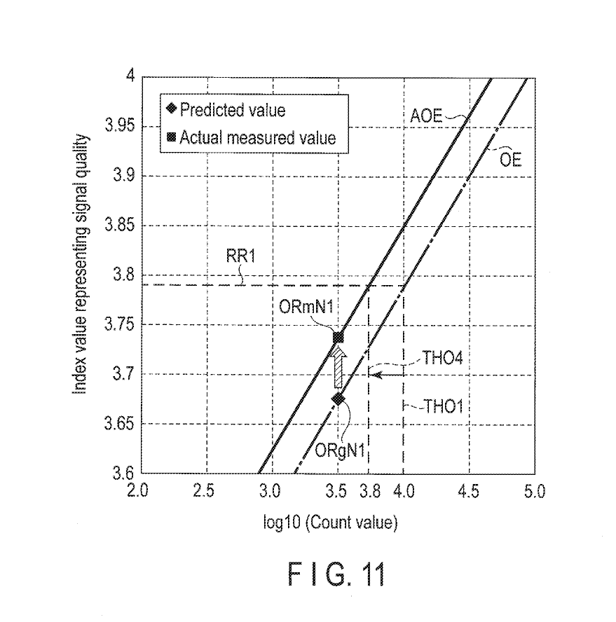

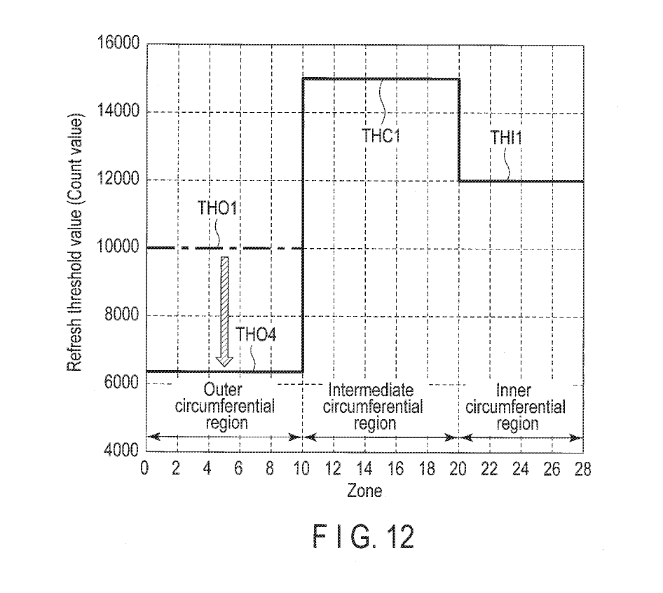

FIG. 11 is a view illustrating an example of how to correct the approximate expression of the outer circumferential region of the modification 2. FIG. 12 is a view illustrating an example of how to correct the refresh threshold value of the outer circumferential region of the modification 2. In FIG. 11, the vertical axis represents the index which represents signal quality, and the horizontal axis represents the count as a common logarithm. Moreover, in FIG. 12, the vertical axis represents the refresh threshold value (count value), and the horizontal axis represents the zone of the recording area 11a. In FIG. 11, RR1 is a line which indicates the index (specific value) corresponding to the refresh threshold value before correction, and THO4 indicates the refresh threshold value after correction of the outer circumferential region in FIG. 11 and FIG. 12.

As illustrated in FIG. 11, when the actual measured value ORmN1 is larger than the predicted value ORgN1, the MPU 60 substitutes the approximate expression AOE for the approximate expression OE, so that the line expressed by the approximate expression OE may pass through the actual measured value ORmN1.

The MPU 60 calculates the refresh threshold value THO4 based on a specific value and the approximate expression AOE after correction. For example, as illustrated in FIG. 11, the MPU 60 calculates the refresh threshold value THO4 with reference to the specific value RR1 and the approximate expression AOE. As illustrated in FIG. 12, the MPU 60 carries out correction which reduces the outer circumferential region from the refresh threshold value THO1 to the calculated refresh threshold value THO4.

Furthermore, the MPU 60 can correct the approximate expression and refresh threshold value of the intermediate circumferential region and those of the inner circumferential region similarly as correction of the approximate expression E41 and refresh threshold value of the outer circumferential region.

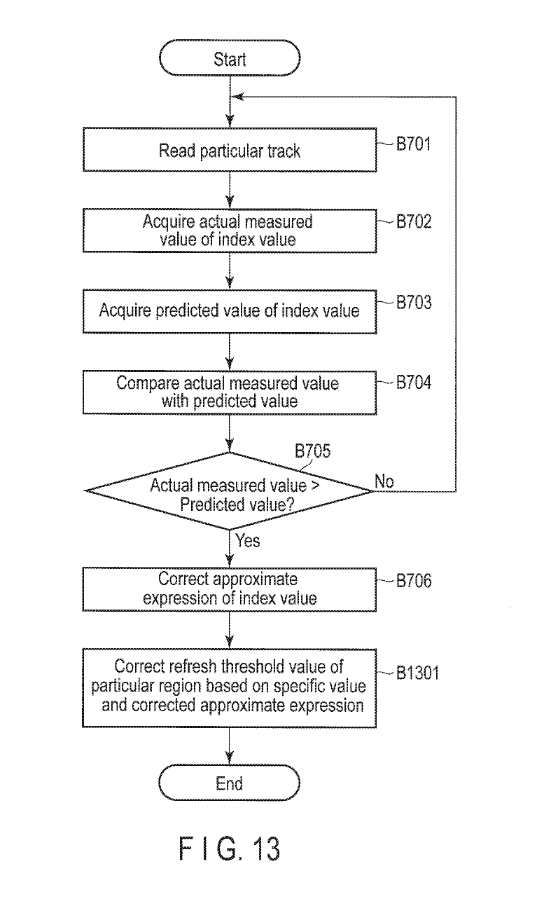

FIG. 13 is a flowchart of a correction process of the refresh threshold value of the modification 2. In the flow chart of FIG. 13, the same reference marks are attached to those processes that are equivalent to the processes of the flow chart of FIG. 7, and the detailed explanation will be simplified or omitted.

The MPU 60 reads a particular track (B701), acquires the actual measured value Rm of the index value of the read particular track (B702), and acquires the predicted value Rg of the index value of a zone including the particular track (B703).

The MPU 60 compares the acquired actual measured value Rm and the acquired predicted value Rg (B704), and determines whether the actual measured value Rm is larger than the predicted value Rg (B705). When it is determined that the actual measured value Rm of the index value is smaller than the predicted value Rg (NO of B705), the MPU 60 returns to the process of B701. When it is determined that the actual measured value Rm is larger than the predicted value Rg (YES of B705), the MPU 60 corrects the approximate expression of the index value (B706).

The MPU 60 corrects the refresh threshold value of the region, to which the zone including the read particular track belongs, based on the corrected approximate expression AOE and a corrected specific value (B1301), and ends the process. Here, the MPU 60 calculates the refresh threshold value THO4 based on the corrected specific value RR1 and the corrected approximate expression AOE, for example. That is, the MPU 60 subjects the outer circumferential region to correction which replaces the refresh threshold value THO1, which is high, with the refresh threshold value THO4, which is low.

The magnetic disk device 1 in the present modification corrects the approximate expression for calculating the predicted value Rg, when the actual measured value Rm acquired by reading a particular track is larger than the predicted value Rg of an index value. At this moment, the magnetic disk device 1 corrects the refresh threshold value of the region, to which the zone including the track belongs, based on the corrected approximate expression AOE and the corrected specific value. Accordingly, the magnetic disk device 1 can subject the particular zone to a refresh process before the index value of the particular zone reaches an upper limit value.

Furthermore, in the above-mentioned embodiment, although the case where the actual measured value Rm is larger than the predicted value Rg has been described, the MPU 60 may correct the approximate expression E41 and the refresh threshold value when the actual measured value Rm is smaller than the predicted value Rg. At this moment, the MPU 60 may carry out correction which raises the refresh threshold value.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic disk device comprising:
a disk comprising a recording surface;
a head configured to write and read data to and from the disk; and
a controller configured to correct a threshold value causing data written in a track in at least one recording area of recording areas radially sectioned on the recording surface of the disk to be rewritten according to an index value indicative of signal quality of the data in the track and variable with the number of times of executed writing into the track.

2. The magnetic disk device of claim 1, wherein the controller compares a measured value of the index value measured upon one track in the recording areas having been read and a predicted value of the index value obtained by assigning a write number of the recording area including the one track to an approximate expression indicative of a relationship between the index value and the write number, and reduces the threshold value upon the measured value being larger than the predicted value.

3. The magnetic disk device of claim 2, wherein the controller corrects the approximate expression based on the measured value.

4. The magnetic disk device of claim 3, wherein the controller reduces the threshold value based on the corrected approximate expression and the index value corresponding to the threshold value.

5. The magnetic disk device of claim 3, wherein the controller corrects the approximate expression according to a difference between the measured value and the predicted value.

6. The magnetic disk device of claim 2, wherein the controller reduces the threshold value by a particular ratio.

7. The magnetic disk device of claim 2, wherein the controller reduces the threshold value based on a ratio between the measured value and the predicted value.

8. The magnetic disk device of claim 2, wherein the controller calculates a predicted value for every section obtained by further sectioning the recording areas.

9. The magnetic disk device of claim 2, wherein the controller sets a approximate expression and a threshold value for every recording area.

10. The magnetic disk device of claim 1, wherein the index value is one of a VMM, an error rate, and an error bit number.

11. A correction method for refresh processing of a magnetic disk device comprising a disk comprising a recording surface and a head configured to write and read data to and from the disk, the correction method comprising:
correcting a threshold value causing data written in a track in at least one recording area of recording areas radially sectioned on the recording surface of the disk to be rewritten according to an index indicative of signal quality of the data in the track and variable with the number of times of executed writing into the track.

12. The method of claim 11, further comprising:
comparing a measured value of the index value measured upon one track in the recording areas having been read and a predicted value of the index value obtained by assigning a write number of the recording area including the one track to an approximate expression indicative of a relationship between the index value and the write number; and
reducing the threshold value upon the measured value being larger than the predicted value.

13. The method of claim 12, further comprising:
correcting the approximate expression based on the measured value.

14. The method of claim 13, further comprising:
reducing the threshold value based on the corrected approximate expression and the index value corresponding to the threshold value.

15. The method of claim 13, further comprising:
correcting the approximate expression according to a difference between the measured value and the predicted value.

16. The method of claim 12, further comprising:
reducing the threshold value by a particular ratio.

17. The method of claim 12, further comprising:
reducing the threshold value based on a ratio between the measured value and the predicted value.

18. The method of claim 12, further comprising:
calculating a predicted value for every section obtained by further sectioning the recording areas.

19. The method of claim 12, further comprising:
setting a approximate expression and a threshold value for every recording area.

20. The method of claim 11, wherein the index value is one of a VMM, an error rate, and a correction error bit number.
